(19) United States
(12) Patent Application Publication
(10) Pub. No.: US 2014/0167944 A1
(43) Pub. Date: Jun. 19, 2014

(54) DISPLAY DEVICE

(71) Applicant: TOYOTA JIDOSHA KABUSHIKI KAISHA, Toyota-shi (JP)

(72) Inventor: Kazuhi Yamaguchi, Kobe-shi (JP)

(21) Appl. No.: 14/005,022

(22) PCT Filed: Dec. 18, 2012
(86) PCT No.: PCT/JP2012/082840

§ 371 Date: Sep. 13, 2013

(51) Int. Cl. B60Q 1/00

(52) U.S. Cl. CPC B60Q 1/00
USPC 340/439

(57) ABSTRACT

Each of an accelerator operation amount and a brake operation amount is displayed as an amount of displacement in the same direction (same side) from a reference position. Also, respective boundaries (or ranges) are displayed in the same direction for determining whether or not the accelerator operation amount during accelerator operation is in a fuel efficient region and whether or not the brake operation amount during the brake operation is in the fuel efficient region. With such a configuration, respective target positions (positions of the respective boundaries (ranges) for determining the fuel efficient region) during accelerator operation and during brake operation are in the same side, thus a driver can operate the vehicle without confusion.

### TECHNICAL FIELD

The present invention relates to a display device for displaying a driving state of a vehicle by a driver.

### BACKGROUND ART

In a vehicle on which an engine (internal combustion engine) is mounted, in some cases is equipped a display device to teach a driver a driving operation to implement fuel consumption (fuel consumption rate). Patent Document 1 discloses, for example, a display device that displays an accelerator operation amount and a brake operation amount by a driver as respective amounts of displacement each extending in different direction from a reference position. Patent Document 1 also discloses boundaries at both sides opposed to each other with respect to the reference position. By the boundaries, it is possible to visually distinguish whether the accelerator operation amount and the brake operation amount are in respective fuel efficient regions or respective fuel inefficient regions.

With the above-mentioned display device, it is possible to visually recognize the current accelerator operation amount and the current brake operation amount as well as the boundaries that define fuel efficient regions. Thus, a driver can drive the vehicle with good fuel consumption by paying attention that the respective operation amounts are not beyond the boundaries.

### PRIOR ART REFERENCE

### Patent Document

[Patent Document 1] JP 2010-085483A

### SUMMARY OF THE INVENTION

### Problems to be Solved by the Invention

Note that in the above-described display device recited in Patent Document 1 (conventional display device), the accelerator operation amount and the brake operation amount are displayed so as to extend in the different direction (side) from each other in displayed graphics. Furthermore, whether the accelerator operation amount and the brake operation amount are in the respective fuel efficient ranges can be distinguished by the respective boundaries that exist in the different directions from each other with respect to the reference position. For this reason, if the driver changes the foot position between the accelerator pedal and the brake pedal, the displayed graphics are greatly changed, thereby the boundary to which the driver should pay attention also changes in the different direction beyond the reference position.

In this way, in the conventional display device, although the driver operates the foot pedal in either case of the accelerator operation or the brake operation, there are two targets in the different directions with respect to the reference position, and thus, the driver is confused to know which target should be focused on to operate the vehicle.

The present invention was made in consideration of such circumstances, and it is an object thereof to provide a display device displaying a driving operation state of a vehicle by a driver, such that the driver is not confused by the display.

### Means for Solving Problem

The present invention provides a display device displaying a driving operation state of a vehicle by a driver in which in response to an accelerator operation, an accelerator operation amount is displayed as an amount of displacement from a reference position in one direction, and a boundary or range is displayed at a position spaced apart from the reference position by a prescribed distance in the one direction such that the accelerator operation amount can be visually determined to be in an fuel efficient region, and in which in response to a brake operation, a brake operation amount is displayed as an amount of displacement from the reference position in the one direction, and a boundary or range is displayed at a position spaced apart from the reference position by a prescribed distance in the one direction such that the brake operation amount can be visually determined to be in the fuel efficient region.

With the present invention, the accelerator operation amount and the brake operation amount are displayed as an amount of change in the same direction (same side) from the reference position. Furthermore, the boundary (or range) for distinguishing between the fuel efficient region and the fuel inefficient region is displayed in the same direction. In this way, a target position (the position of the boundary or range for distinguishing the fuel efficient region) is always in the same side regardless of which operation is performed, the accelerator operation or the brake operation, and thus, the driver can operate without confusion.

The present invention may include a specific configuration in which during the accelerator operation, neither the brake operation amount nor the boundary or range for visually determining the brake operation amount being in the fuel efficient region is displayed. Also, the present invention may include a specific configuration in which during the brake operation, neither the accelerator operation amount nor the boundary or range for visually determining the accelerator operation amount being in the fuel efficient region is displayed.

With such a configuration, it is possible to switch, in the same display unit provided, for example, on a combination meter, the display of the accelerator operation amount and the boundary (range), and the display of the brake operation amount and the boundary (range) according to operations of the foot pedal (changing stepping between the accelerator pedal and the brake pedal).

In the present invention, it is preferable that both the boundary or range for visually determining the accelerator operation amount and the boundary or range for visually determining the brake operation amount are displayed at a position spaced apart from the reference position by the same distance. With such a configuration, it is possible to keep and not change the reference position and the position of the boundary (range) regardless of whether the accelerator operation or the brake operation is performed. Thus, during the accelerator operation and the brake operation, the driver can confirm more easily whether the current operation amount is in the fuel efficient region. Furthermore, if the display is switched between the accelerator operation and the brake operation, the reference position and the boundary (range) are displayed in the respective same positions, which allows the driver not to feel weird.

The present invention may include a specific configuration in which the vehicle is an idle stop vehicle capable of performing an automatic engine stop based on the brake operation amount, and in which a display during the brake operation before the automatic engine stop is a display of a boundary or range for visually determining whether or not the brake operation amount is in an automatic engine stop permission range. With such a configuration, before the automatic engine stop (before idle stop), the driver can visually determine whether or not the current brake operation amount reaches the automatic engine stop permission range. Also, the driver can visually determine to what degree the brake pedal should be stepped to make the vehicle be in the automatic engine stop state.

The present invention may include a specific configuration in which the vehicle is an idle stop vehicle capable of performing an automatic engine start based on the brake operation amount, and in which a display of the brake operation amount during the automatic engine stop is a display of a boundary or range for visually determining whether or not the brake operation amount is in an automatic engine start permission range. With such a configuration, the driver can visually determine whether or not the current brake operation amount is in the automatic engine start permission range. Also, the driver can visually determine to what degree the brake pedal should be released to make the vehicle automatically be started.

The present invention may include a specific configuration in which the vehicle is an idle stop vehicle capable of performing an automatic engine start based on the brake operation amount, and in which a display during the automatic engine stop is a display selected from the following three displays: a display of a boundary or range for visually determining whether or not an electrical power use state is in an automatic engine stop continuable range; a display of a boundary or range for visually determining whether or not an air conditioner use state is in the automatic engine stop continuable range; and the display of a boundary or range for visually determining whether or not the brake operation amount is in an automatic engine start permission range.

In this case, the above-described three displays may be switched for a predetermined time period, or, among the brake operation amount, the electrical power use state and the air conditioner use state, a display bar extending closest to the boundary (range) may be selected to be displayed.

### Effects of the Invention

According to the present invention, in a display device for displaying a driving operation state of a vehicle by a driver, it is possible to realize the display that the driver can visually confirm without confusion.

### BRIEF DESCRIPTION OF DRAWINGS

FIG. 1 is a schematic configuration diagram showing an example of a vehicle to which a display device of the present invention is applied.

FIG. 2 shows an example of a combination meter mounted on the vehicle shown in FIG. 1.

FIG. 3 is a block diagram showing a configuration of a control system such as an ECU.

FIG. 4(A) shows a display example of an accelerator operation amount during travel, FIG. 4(B) shows a display example of a brake operation amount during deceleration, and FIG. 4(C) shows a display example of a brake operation amount during stop (before idle stop) of a vehicle.

FIG. 5(A) shows a display example of an accelerator operation amount during travel, FIG. 5(B) shows a display example of a brake operation amount during deceleration, and FIG. 5(C) shows a display example of a brake operation amount during stop (before idle stop) of a vehicle.

FIG. 6 shows an example of a map for obtaining an accelerator operation amount determination threshold value to determine whether a fuel efficient drive is performed.

FIG. 7 shows an example of a map for obtaining a brake operation amount determination threshold value to determine whether a fuel efficient drive is performed.

FIG. 8 shows a display example of an electrical power use state during idle stop.

FIG. 9 is a flowchart showing an example of a display control performed by an ECU.

FIG. 10 is a flowchart showing an example of a display control performed by an ECU.

FIG. 11(A) shows a display example of an electrical power use state during idle stop, FIG. 11(B) shows a display example of an air conditioner use state during idle stop, and FIG. 11(C) shows a brake operation amount during idle stop.

FIG. 12 shows another display example of a brake operation amount.

FIG. 13 shows a display example of a clutch operation amount during stop (before idle stop) of a vehicle.

FIG. 14 shows a display example of a clutch operation amount during idle stop.

### MODES FOR CARRYING OUT THE INVENTION

Hereinafter, embodiments of the present invention will be described with reference to the drawings.

### Embodiment 1

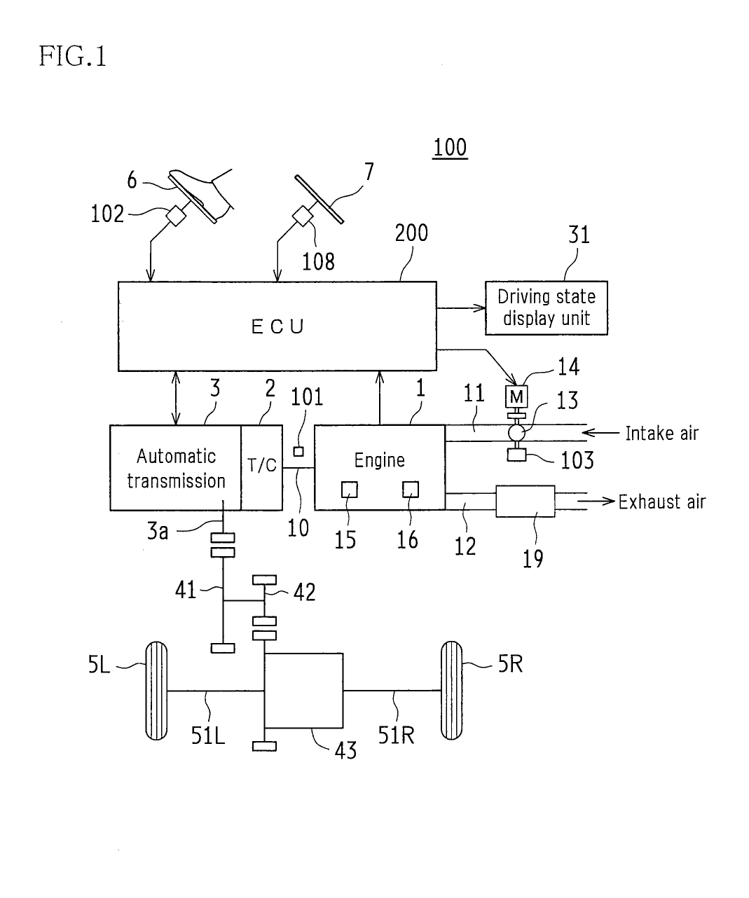

FIG. 1 is a schematic configuration diagram showing an example of a vehicle to which is applied a display device according to the present invention.

A vehicle 100 in this example is an FF (front engine front drive) vehicle. The vehicle 100 includes an engine 1, an automatic transmission 3 having a torque converter 2, a driven gear 41, a final gear 42, a differential device 43, drive shafts 51L and 51R, drive wheels (front wheels) 5L and 5R, driven wheels (rear wheels, not shown), an ECU (Electric Control Unit) 200 and the like. The display device according to the present invention is constituted of the ECU 200, a driving state display unit 31, sensors 102, 107 and 108 and the like. The driving state display unit 31 and sensors 102, 107 and 108 will be described later.

The ECU 200 is constituted, for example, of an engine ECU, an idle stop ECU, a battery ECU, a meter ECU and an air conditioner ECU, which are communicably connected to each other.

Next, each portion of the vehicle such as the engine 1, the torque converter 2, and the automatic transmission 3 will be described.

—Engine—

The engine 1 is a known power unit such as a gasoline engine and a diesel engine that outputs power by fuel combustion. The engine 1 is configured so as to control a driving state such as a throttle opening of a throttle valve 13 that is provided in an intake path 11, a fuel injection amount of a fuel injection device 15, and an ignition timing of an ignition device 16. The engine 1 is provided with a crank position sensor 101 that detects a rotation angle (crank angle) of a crankshaft 10 serving as an output shaft. An engine rotation speed can be calculated based on an output signal of the crank position sensor 101. An exhaust path 12 is connected to the engine 1. An exhaust gas produced after combustion passes through the exhaust path 12, undergoes purification by an exhaust emission control device 19 such as an oxidization catalyst (not shown), and thereafter is released into the air.

In order to control the throttle valve 13 of the engine 1, for example, a known electronic throttle control system is adopted. The electronic throttle control system controls a throttle opening so as to obtain an optimum intake air amount (target intake air amount) according to a state of the engine 1 such as an engine rotation speed, and a stepping amount (accelerator opening) of an accelerator pedal 6 by a driver. The opening of the throttle valve 13 is detected by a throttle position sensor 103.

—Torque Converter—

The torque converter (T/C) 2 is provided with an input shaft side pump impeller, an output shaft side turbine runner, a stator that realizes a torque amplification function, a lock-up clutch and the like. The torque converter 2 is a known fluid coupling that transmits power between the pump impeller and the turbine runner via a fluid (ATF). The pump impeller of the torque converter 2 is linked to the crankshaft 10 of the engine 1. The turbine runner is linked to the input shaft of the automatic transmission 3.

—Automatic Transmission—

The automatic transmission 3 is a belt type continuously variable transmission (CVT) performing stepless adjustment of a gear ratio, which is provided with, for example, a primary pulley, a secondary pulley, and a belt that is wrapped around between the primary pulley and the secondary pulley. A forward/reverse travel switching device (not shown) is provided in a power transmission path between the automatic transmission (continuously variable transmission) 3 and the torque converter 2.

In the automatic transmission (continuously variable transmission) 3 of this example, the gear shift mode can be set, by control of the ECU, to an automatic gear shift mode or a manual gear shift mode that changes a plurality of gear ratio (gear stages) being previously set stepwise in the same manner as a multistage transmission.

Power (power of the engine 1) transmitted to the output shaft of the automatic transmission 3 is transmitted to an output gear 3a, the driven gear 41, the final gear 42, the differential device 43, and left and right drive wheels 5L and 5R through the drive shafts 51L and 51R.

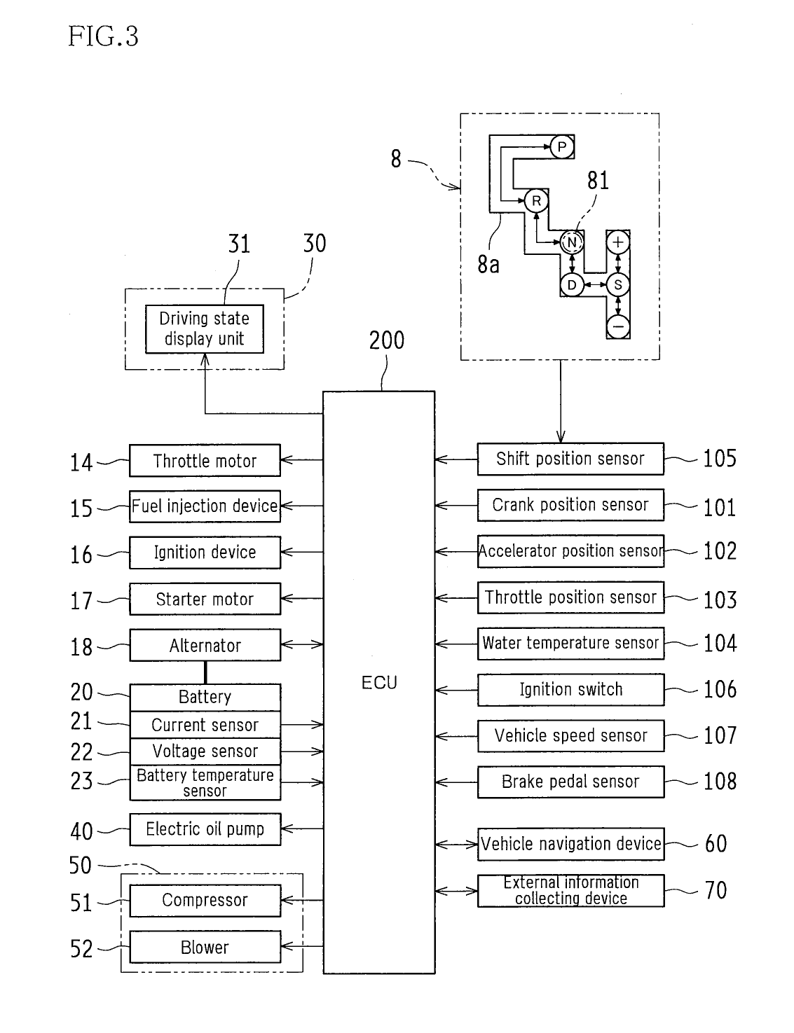

In this configuration, as a hydraulic pressure source of a hydraulic control circuit that performs hydraulic pressure control of the automatic transmission 3, an oil pump (not shown) mechanically driven by the power from the engine 1 and an electric oil pump 40 (see FIG. 3) are provided. For example, the electric oil pump 40 secures a hydraulic pressure during engine stop by idle stop control that will be described later, or a hydraulic pressure at a time of restarting after engine stop.

As the automatic transmission 3, another type of automatic transmission may be used, such as a troidal type continuously variable transmission, and a multistage (planetary gear type) automatic transmission that sets a gear stage using frictional engagement devices (e.g. a clutch and a brake) and a planetary gear device.

—Starter Motor, Alternator and the Like—

The vehicle 100 of this example includes a starter motor 17, an alternator 18, a battery 20, an air conditioner 50 and the like, as shown in FIG. 3.

The starter motor 17 is provided to perform motoring (cranking) when starting the engine 1. The starter motor 17 is driven by an electrical power supplied from the battery 20.

The alternator 18 is coupled to the crankshaft 10 of the engine 1 via a pulley, a transmission belt and the like. The alternator 18 is rotated according to running of the engine 1 to generate an electrical power. The electrical power generated by the alternator 18 is supplied to various electric loads mounted on a vehicle as well as to the battery 20.

The battery 20 is, for example, a lead battery capable of charging and discharging, which has a function of supplying electrical power to accessory machines mounted on the vehicle 100. For example, the battery 20 supplies electrical power to the starter motor 17 when the engine 1 is started. The battery 20 is charged by an electrical power generated by the alternator 18 during running of the engine 1. As shown in FIG. 3, the battery 20 is provided with a current sensor 21 that detects a charging/discharging current of the battery 20, a voltage sensor 22 that detects a voltage and a battery temperature sensor 23 that detects a battery temperature. Detected results of the current sensor 21, the battery sensor 22 and the battery temperature sensor 23 are input into the ECU 200. The ECU 200 monitors the state of the battery 20 based on the detected results.

### (Air Conditioner)

The air conditioner 50 (see FIG. 3) for cooling and heating the vehicle cabin is mounted on the vehicle 100 of this example. The air conditioner 50 is provided with an air-conditioning duct (not shown) that forms an air path for guiding conditioned air to the cabin of the vehicle 100, a blower 52 that generates airflow in the air-conditioning duct, a refrigerating cycle (a compressor 51, a capacitor, an expansion valve, an evaporator and the like) for cooling air that passes through the air-conditioning duct mainly when cooling the vehicle cabin, and a heater core (not shown) for heating air that passes through the air-conditioning duct mainly when heating the vehicle cabin. Furthermore, the air conditioner 50 is provided with a temperature setting switch for setting a cabin temperature, a blower switch for setting a blower flow rate and the like.

—Shift Operating Device—

The vehicle 100 of this example is provided with a shift operating device 8 as shown in FIG. 3. The shift operating device 8 is disposed in the vicinity of the driver's seat, and is provided with a shift lever 81 that can be operated and moved.

A shift gate 8a, which has a parking position (P position), a reverse position (R position), a neutral position (N position), a drive position (D position), and a sequential position (S position), is formed in the shift operating device 8 such that the driver can move the shift lever 81 to any desired shift position. All these positions, namely, the P position, the R position, the N position, the D position and the S position are detected by a shift position sensor 105.

When the above shift lever 81 is operated to the D position, the shift mode is set to an automatic gear shift mode, where gear shift control of the automatic transmission 3 is performed by referring to a predetermined gear shift map according to a vehicle speed and an accelerator operation amount, and thus determining a target gear stage. On the other hand, when the shift lever 81 is operated to the S position, the shift mode is set to a manual gear shift mode (sequential shift mode) manually operated by the driver.

—Driving State Display Unit—

The vehicle 100 of this example is equipped with the driving state display unit (eco-drive indicator) 31 that displays a driving operation state (driving operation amount) of the vehicle by the driver, an electrical power use state, an air conditioner use state and the like. Hereinafter, the driving state display unit 31 will be described.

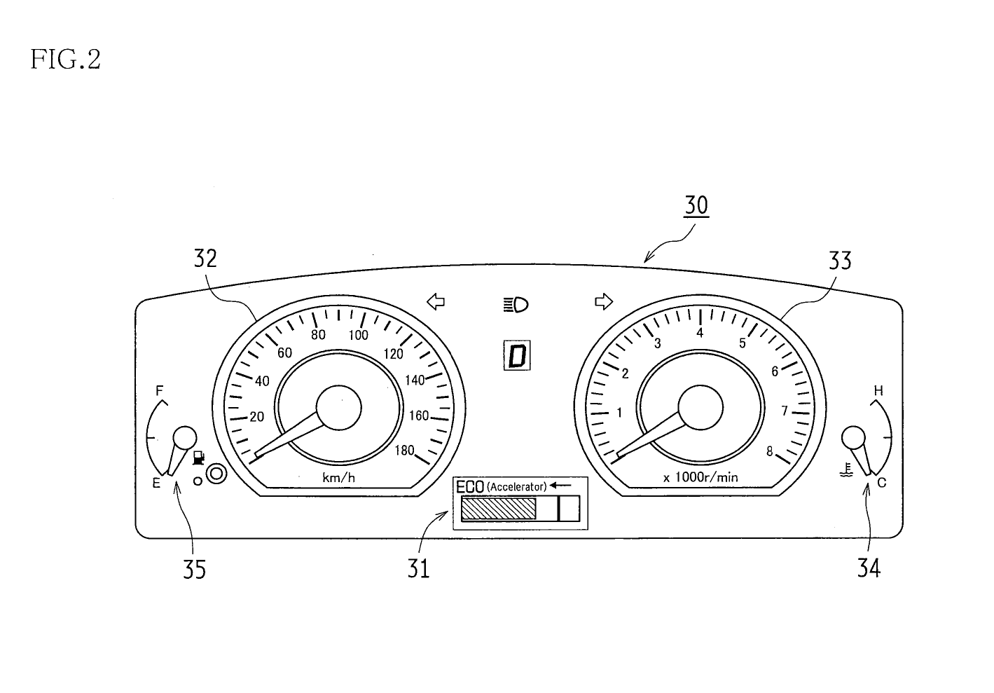

As shown in FIG. 2, a combination meter 30 is disposed in front of the driver's seat in the vehicle cabin. A speedometer 32, a tachometer 33, a water temperature gauge 34, a fuel gauge 35, an odometer (not shown), a tripmeter (not shown), various warning indicator lamps and the like are disposed on the combination meter 30. Also, the driving state display unit 31 is disposed on the central portion of the combination meter 30. An LCD (Liquid Crystal Display) is adopted, for example, as the driving state display unit 31.

The ECU 200 controls all the displays or indications of the above-described meters and the like of the combination meter 30, as well as the display of the driving state display unit 31. The display of the driving state display unit 31 is switched according to each driving operation state of the vehicle 100, namely, [during travel], [during deceleration], [during stop (before idle stop)] and [during idle stop]. Display examples of the driving state display unit 31 according to the respective driving operation states will be described later.

—ECU—

The ECU 200 includes a CPU (Central Processing Unit), a ROM (Read Only Memory), a RAM (Random Access Memory), a backup RAM and the like.

The ROM stores various control programs as well as maps that are referred to when the control programs are executed. The CPU executes computation processing based on the various control programs and maps stored in the ROM. The RAM is a memory that temporarily stores results of computation performed by the CPU and data input from each sensor. The backup RAM is a nonvolatile memory that stores data and the like that need to be saved during ignition-off, for example.

As shown in FIG. 3, to the ECU 200 are connected the crank position sensor 101, an accelerator position sensor 102 that detects an operation amount (accelerator opening) of the accelerator pedal 6 (see FIG. 1), the throttle position sensor 103 that detects an opening of the throttle valve 13 of the engine 1, a water temperature sensor 104 that detects an engine water temperature (cooling water temperature), the shift position sensor 105, an ignition switch 106, the vehicle speed sensor 107 that outputs a signal according to the vehicle speed, the brake pedal sensor 108 that detects an operation amount (stepping amount) of a brake pedal 7 (see FIG. 1) that is operated by the driver, and the like. Also, to the ECU 200 are connected sensors indicating the driving state of the engine 1, such as an air flow meter that detects an intake air amount, an intake air temperature sensor that detects an intake air temperature, an air-fuel ratio sensor that detects an A/F (exhaust A/F) of exhaust gas, and an O₂ sensor that detects an oxygen concentration in exhaust gas. Signals from the above sensors are input to the ECU 200. Furthermore, to the ECU 200, the current sensor 21, the voltage sensor 22, the battery temperature sensor 23 and the like are connected, and signals from the above sensors are also input to the ECU 200.

Furthermore, to the ECU 200 are connected a throttle motor 14 that opens and closes the throttle valve 13 of the engine 1, a fuel injection device (an injector and the like) 15, an ignition device (a spark plug, an igniter and the like) 16, the starter motor 17, the alternator 18, the electric oil pump 40, the compressor 51 for air conditioning, the blower 52 and the like.

Furthermore, a vehicle navigation device 60 and an external information collecting device 70 are connected to the ECU 200. The vehicle navigation device 60 is an in-vehicle device for setting a travel route using a position of a user's vehicle specified by communication with global positioning system (GPS) satellites and map data so as to guide the user's vehicle.

The external information collecting device 70 collects information on a road geometry, occurrence of a traffic jam, presence of traffic accidents or road works, weather, road conditions and the like, by receiving road traffic information provided by VICS (registered trade name: Vehicle Information and Communication System) or by communicating with a roadside communication device disposed at the roadside.

The ECU performs, based on output signals from the above-described sensors, various kinds of control of the engine 1 including opening control (intake air amount control) of the throttle valve 13 of the engine 1, fuel injection amount control (opening/closing control of the injector), ignition timing control (driving control of the spark plug) and the like. Also, when the shift lever 81 is operated to the D position, the ECU 200 performs gear shift control of the automatic transmission 3 by referring to the predetermined gear shift map according to a vehicle speed and an accelerator operation amount, and thus determining a target gear stage (automatic gear shift mode). On the other hand, when the shift lever 81 is operated to the S position, the ECU 200 performs gear shift control of the automatic transmission 3 according to a manual gear shift operation by the driver (sequential shift mode).

Furthermore, the ECU 200 performs [idle stop control] and [display control of the driving state display unit].

—Idle Stop Control—

The vehicle 100 of this example is an idle stop vehicle. The ECU 200 can automatically stop the engine 1 upon satisfaction of idle stop conditions (automatic engine stop conditions) and can automatically start the engine 1 upon satisfaction of an idle stop release condition (automatic engine start condition). Namely, the ECU 200 can perform idle stop control (economical running control).

The idle stop conditions are set to include, for example, an on-state of the ignition switch 106 (IG-ON), an accelerator-off (recognized from an output signal of the accelerator position sensor 102), a brake operation amount (recognized from an output signal of the brake pedal sensor 108) equal to or more than a predetermined determination threshold value THbrk 1 and a vehicle stop state (in which the vehicle speed is zero; recognized from an output signal of the vehicle speed sensor 107). Once such idle stop conditions are satisfied, the ECU 200 instructs the fuel injection device 15 to stop fuel injection (fuel cut-off) such that the engine 1 is automatically stopped (automatic engine stop). In addition to the fuel cut-off, ignition cut-off may be performed.

The idle stop release condition is a condition in which, after satisfaction of the idle stop conditions, the brake operation amount (recognized from the output signal of the brake pedal sensor 108) becomes less than a predetermined determination threshold value THbrk 2 (for example, THbrk 2<THbrk 1) due to, for example, decrease of a stepping amount of the brake pedal 7. Once such an idle stop release condition is satisfied in a state in which the engine 1 is automatically stopped (idle stop state), the ECU 200 instructs the injection device 16 to start fuel injection and the starter motor 17 to run and perform cranking of the engine 1 such that the engine 1 is automatically restarted (automatic engine start).

—Display Control of Driving State Display Unit—

Next, a description will be given with respect to display control of the driving state display unit 31 performed by the ECU 200.

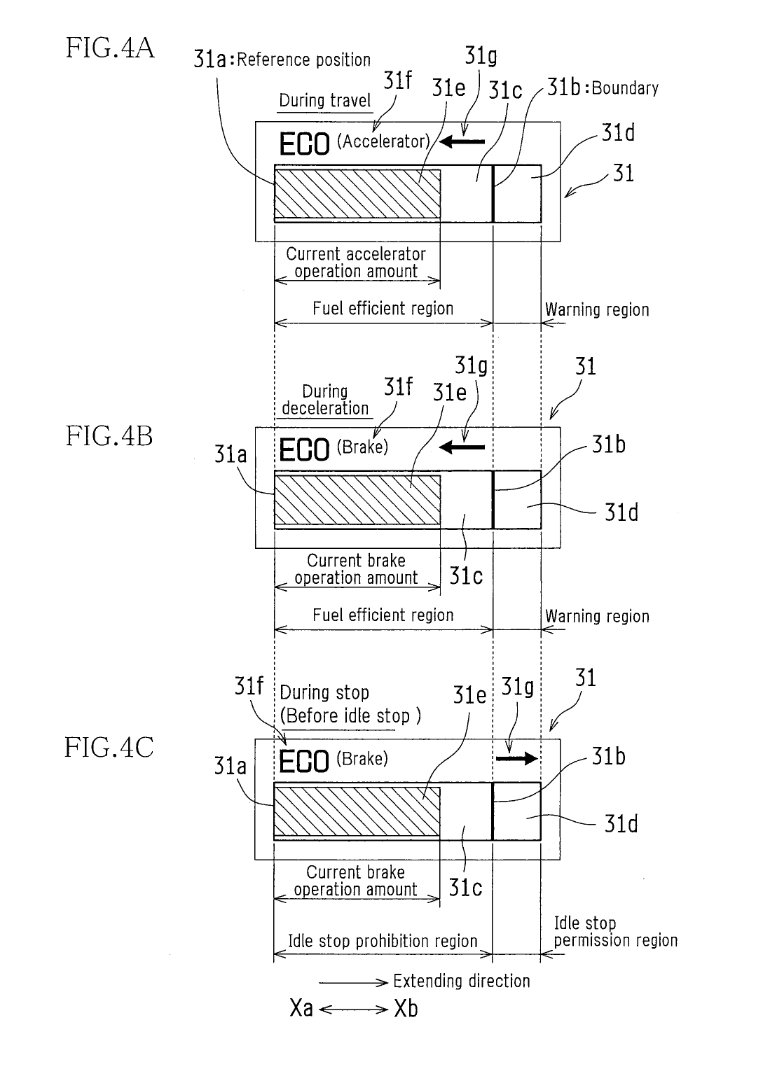

In the present embodiment, the display of the driving state display unit 31 is switched according to each driving operation state of the vehicle 100, namely, [during travel], [during deceleration], [during stop (before idle stop)] and [during idle stop]. Display examples of the driving state display unit 31 according to the respective driving operation states will be described with reference to FIGS. 4-8.

[During Travel]

During travel of the vehicle 100, the display of the driving state display unit 31 is a display shown in FIG. 4(A) (display indicating an accelerator operation amount).

Specifically, the driving state display unit 31 displays: a reference position 31a; a fuel efficient region (eco-drive region) 31c and a warning region 31d, the above two regions are disposed in this order from the reference position 31a in one direction (extending direction: Xb direction); a boundary 31b between the fuel efficient region 31c and the warning region 31d; a bar 31e that extends in one direction (Xb direction) or shortens in an Xa direction based on a current accelerator operation amount (accelerator opening) (hereinafter referred to as an accelerator operation amount display bar 31e); characters “[ECO (Accelerator)]” 31f; and an arrow 31g indicating a low fuel consumption direction.

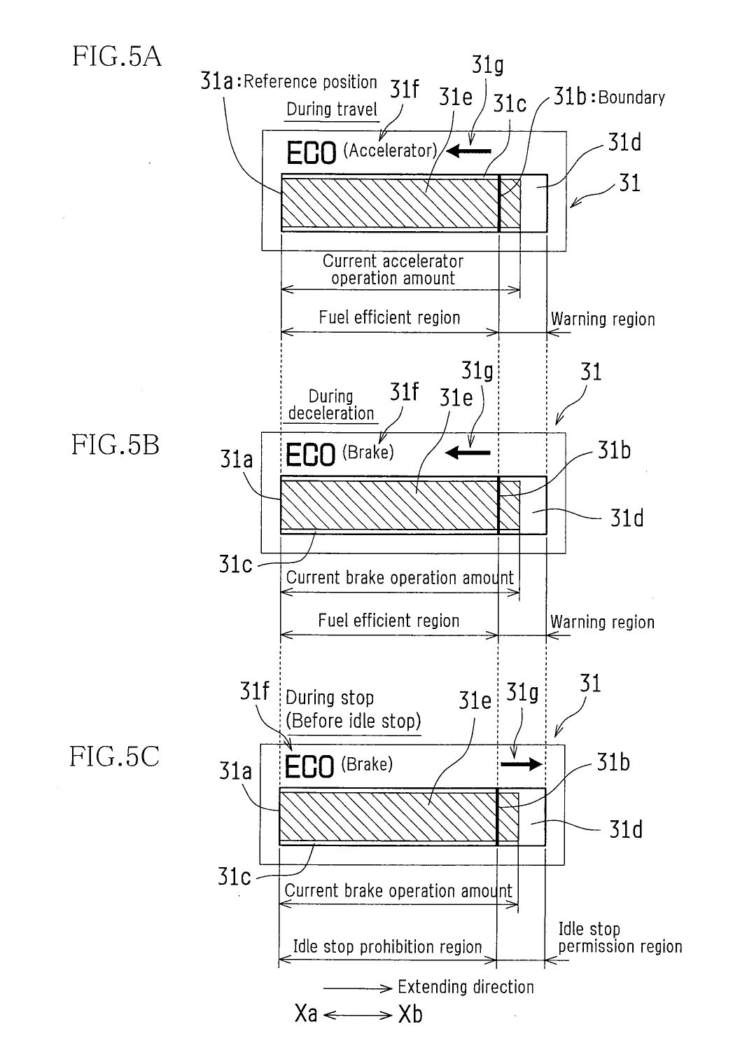

The accelerator operation amount display bar 31e is extendable not only from the reference position 31a to the fuel efficient region 31c but also from the fuel efficient region 31c to the warning region 31d over the boundary 31b (see FIG. 5(A)).

The boundary 31b between the fuel efficient region 31c and the warning region 31d, which is the boundary for visually determining that the accelerator operation amount is in the fuel efficient region, is displayed at a position spaced apart from the reference position 31a by a prescribed distance in one direction (extending direction of the accelerator operation amount display bar 31e: Xb direction). Such a display position of the boundary 31b relative to the reference position 31a is always the same, but a value of the boundary 31b (accelerator operation amount determination threshold value for determining the fuel efficient region) is set according to the vehicle speed.

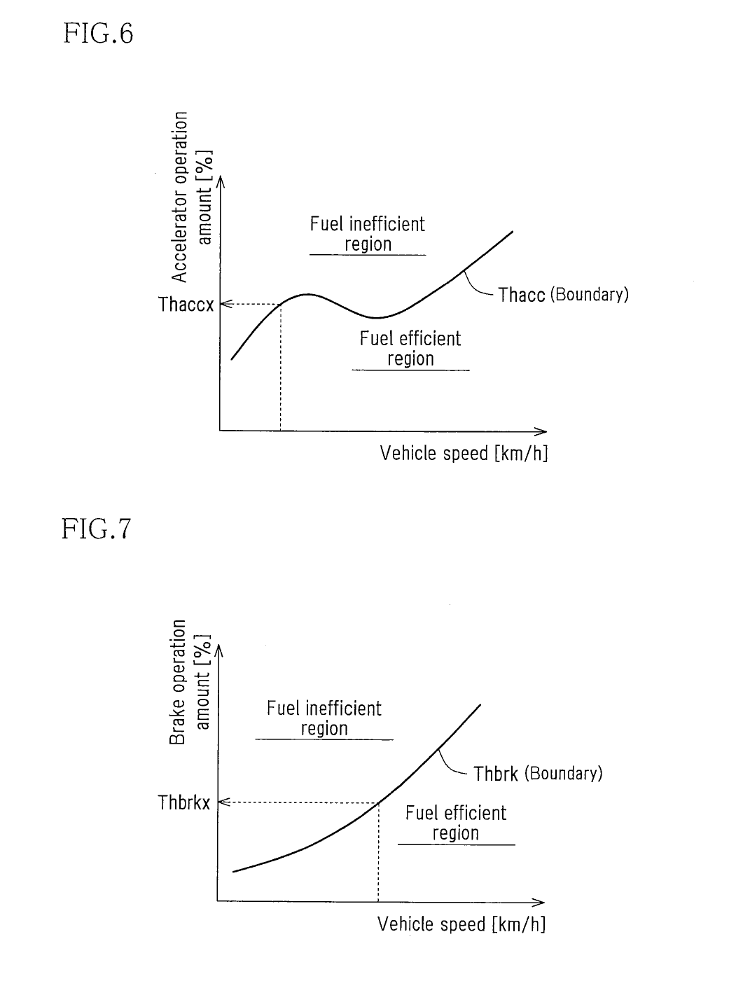

To be specific, for example, an accelerator operation amount determination threshold value Thaccx (%) for determining fuel efficient driving is obtained based on the current vehicle speed (km/h), using a map shown in FIG. 6. The threshold value of the above boundary 31b is set to the above-obtained accelerator operation amount determination threshold value Thaccx, accordingly the threshold value of the boundary 31b is variable according to the vehicle speed.

The map shown in FIG. 6 is formed with the vehicle speed (km/h) and the accelerator operation amount (%) as parameters. The map is generated, based on previous experiments and simulations, by adapting an accelerator operation amount determination threshold value Thacc (boundary) for distinguishing (determining) the fuel efficient region (eco-drive region) where fuel consumption of the engine 1 is good and the fuel inefficient region (non-eco-drive region) where fuel consumption of the engine 1 is not good. The map is stored in the ROM of the ECU 200.

The fuel inefficient region corresponds to a drive region where fuel consumption is not good due to an accelerator operation that causes a sudden acceleration or extremely high vehicle speed. The fuel efficient region corresponds to a region except for the above fuel inefficient region, and accordingly is a region where fuel consumption is good.

In this example, the accelerator operation amount determination threshold value Thaccx (%) obtained by the above-described processing and the current accelerator operation amount (%) (recognized from the output signal of the accelerator position sensor 102) are used for calculating a display length of the accelerator operation amount display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the accelerator operation amount display bar 31e is controlled based on the display length that is calculated based on the following formula (1):

Display length of accelerator operation amount display bar 31e=[(Current accelerator operation amount)/(Accelerator operation amount determination threshold value Thaccx)]×100(%) (1)

Thus, by controlling the display of the accelerator operation amount display bar 31e that indicates the current accelerator operation amount, the display length (amount of extension) of the accelerator operation amount display bar 31e changes based on fuel efficiency according to the accelerator operation amount. That is, the display length of the accelerator operation amount display bar 31e gets shorter (i.e. the amount of extension in the Xb direction reduces) as the accelerator operation amount becomes more fuel-efficient. On the other hand, the display length of the accelerator operation amount display bar 31e gets longer (i.e. the amount of extension in the Xb direction increases) as the accelerator operation amount becomes more fuel-inefficient. When the brake pedal 7 is not operated during travel (the brake operation amount equals to zero) and the vehicle is in an accelerator-off state (the accelerator operation amount equals to zero), the amount of extension of the accelerator operation amount display bar 31e is zero (i.e. equals to the reference position 31a).

It is the ECU 200 that executes the above described calculation processing of the accelerator operation amount determination threshold value Thaccx, the calculation processing of the display length of the accelerator operation amount display bar 31e and the display control of the driving state display unit 31 that includes the display control of the accelerator operation amount display bar 31e.

[During Deceleration]

During deceleration (deceleration by a brake operation) of the vehicle 100, the display of the driving state display unit 31 is a display shown in FIG. 4(B) (display indicating a brake operation amount).

Specifically, the driving state display unit 31 displays: a reference position 31a; a fuel efficient region (eco-drive region) 31c and a warning region 31d, the above two regions are disposed in this order from the reference position 31a in one direction (extending direction: Xb direction); a boundary 31b between the fuel efficient region 31c and the warning region 31d; a bar 31e that extends in one direction (Xb direction) or shortens in an Xa direction based on a current brake operation amount (hereinafter referred to as a brake operation amount display bar 31e); characters “[ECO (Brake)]” 31f; and an arrow 31g indicating a low fuel consumption direction.

The brake operation amount display bar 31e is extendable not only from the reference position 31a to the fuel efficient region 31c but also from the fuel efficient region 31c to the warning region 31d over the boundary 31b (see FIG. 5(B)).

The display position indicating the reference position 31a (position in the direction perpendicular to the Xa/Xb direction) in FIG. 4(B) is the same as the display position indicating the reference position 31a in FIG. 4(A). Also, the boundary 31b between the fuel efficient region 31c and the warning region 31d, which is the boundary for visually determining that the brake operation amount is in the fuel efficient region, is displayed at a position spaced apart from the reference position 31a by a prescribed distance (same amount as shown in FIG. 4(A)) in one direction (extending direction of the brake operation amount display bar 31e: Xb direction). Therefore, the boundary 31b in FIG. 4(B) also is displayed at the same position as the boundary 31b in FIG. 4(A).

Also in the boundary 31b of this example, a value of the boundary 31b (brake operation amount determination threshold value for determining the fuel efficient region) is set according to the vehicle speed.

To be specific, for example, a brake operation amount determination threshold value Thbrkx (%) for determining fuel efficient driving is obtained based on the current vehicle speed (km/h), using a map shown in FIG. 7. The threshold value of the above boundary 31b is set to the above-obtained brake operation amount determination threshold value Thbrkx, accordingly the threshold value of the boundary 31b is variable according to the vehicle speed.

The map shown in FIG. 7 is formed with the vehicle speed (km/h) and the brake operation amount (%) as parameters. The map is generated, based on previous experiments and simulations, by adapting a brake operation amount determination threshold value Thbrk (boundary) for distinguishing (determining) the fuel efficient region (eco-drive region) where fuel consumption of the engine 1 is good and the fuel inefficient region (non-eco-drive region) where fuel consumption of the engine 1 is not good. The map is stored in the ROM of the ECU 200.

The fuel inefficient region corresponds to a drive region where fuel consumption is not good due to a sudden braking or unnecessarily frequent brake operations. The fuel efficient region corresponds to a region except for the above fuel inefficient region, and accordingly is a region where fuel consumption is good.

In this example, the brake operation amount determination threshold value Thbrkx (%) obtained by the above-described processing and the current brake operation amount (%) (recognized from the output signal of the brake pedal sensor 108) are used for calculating a display length of the brake operation amount display bar 31e (length from the reference position 31a to the tip portion of the display bar 31e in the extending direction or Xb direction, i.e. amount of displacement of the brake operation amount display bar 31e in one direction from the reference position 31a) that is displayed in the driving state display unit 31. Display of the brake operation amount display bar 31e is controlled based on the display length that is calculated based on the following formula (2):

Display length of brake operation amount display bar 31e=[(Current brake operation amount)/(Brake operation amount determination threshold value Thbrkx)]×100(%) (2)

Thus, by controlling the display of the brake operation amount display bar 31e that indicates the current brake operation amount, the display length (amount of extension) of the brake operation amount display bar 31e changes based on fuel efficiency according to the brake operation amount. That is, the display length of the brake operation amount display bar 31e gets shorter (i.e. the amount of extension in the Xb direction reduces) as the brake operation amount becomes more fuel-efficient. On the other hand, the display length of the brake operation amount display bar 31e gets longer (i.e. the amount of extension in the Xb direction increases) as the brake operation amount becomes more fuel-inefficient.

It is the ECU 200 that executes the above described calculation processing of the brake operation amount determination threshold value Thbrkx, the calculation processing of the display length of the brake operation amount display bar 31e and the display control of the driving state display unit 31 that includes the display control of the brake operation amount display bar 31e.

[During Stop (Before Idle Stop)]

Next, during stop (before idle stop) of the vehicle 100, the display is as shown in FIG. 4(C) (display indicating the brake operation amount).

Specifically, the driving state display unit 31 displays: a reference position 31a; an idle stop prohibition region 31c and an idle stop permission region (automatic engine stop permission range) 31d, the above two regions are disposed in this order from the reference position 31a in one direction (extending direction: Xb direction); a boundary 31b between the idle stop prohibition region 31c and the idle stop permission region 31d; a bar 31e that extends in one direction (Xb direction) or shortens in an Xa direction based on a current brake operation amount (hereinafter referred to as a brake operation amount display bar 31e); characters “[ECO (Brake)]” 31f; and an arrow 31g indicating an idle stop permission direction.

The brake operation amount display bar 31e is extendable not only from the reference position 31a to the idle stop prohibition region 31c but also from the idle stop prohibition region 31c to the idle stop permission region 31d over the boundary 31b (see FIG. 5(C)).

The display position indicating the reference position 31a (position in the direction perpendicular to the Xa/Xb direction) in FIG. 4(C) is the same as the display position indicating the reference position 31a in FIG. 4(A). Also, the boundary 31b between the idle stop prohibition region 31c and the idle stop permission region 31d, which is the boundary for visually determining that the brake operation amount is in the automatic engine stop permission range, is displayed at a position spaced apart from the reference position 31a by a prescribed distance (same amount as shown in FIG. 4(A)) in one direction (extending direction of the brake operation amount display bar 31e: Xb direction). Therefore, the boundary 31b in FIG. 4(C) also is displayed at the same position as the boundary 31b in FIG. 4(A).

The value of the boundary 31b of this example (i.e. the brake operation amount determination threshold value for determining the idle stop permission region) is set to the determination threshold value THbrk1 (%) that is used for determining one condition among the above idle stop conditions, i.e. the condition in which the brake operation amount is equal to or more than the prescribed determination threshold value THbrk1. Therefore, during stop (before idle stop) of the vehicle 100, when the tip portion of the brake operation amount display bar 31e enters the idle stop permission region 31d over the boundary 31b, as shown in FIG. 5(C), one condition among the idle stop conditions is satisfied.

Display control of the brake operation amount display bar 31e during stop (before idle stop) of the vehicle is performed by the following processing. That is, the determination threshold value THbrk1 (%) and the current brake operation amount (%) (recognized from the output signal of the brake pedal sensor 108) are used for calculating a display length of the brake operation amount display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the brake operation amount display bar 31e is controlled based on the display length that is calculated based on the following formula (3):

Display length of brake operation amount display bar 31e=[(Current brake operation amount)/(Determination threshold value THbrk1)]×100(%) (3)

Thus, by controlling the display of the brake operation amount display bar 31e that indicates the current brake operation amount, the display length (amount of extension) of the brake operation amount display bar 31e changes based on the brake operation amount. That is, the display length of the brake operation amount display bar 31e gets longer (i.e. the amount of extension in the Xb direction increases) as the brake operation amount comes closer to the idle stop determination threshold value THbrk1.

It is the ECU 200 that executes the above described calculation processing of the display length of the brake operation amount display bar 31e and the display control of the driving state display unit 31 that includes the display control of the brake operation amount display bar 31e.

[During Idle Stop]

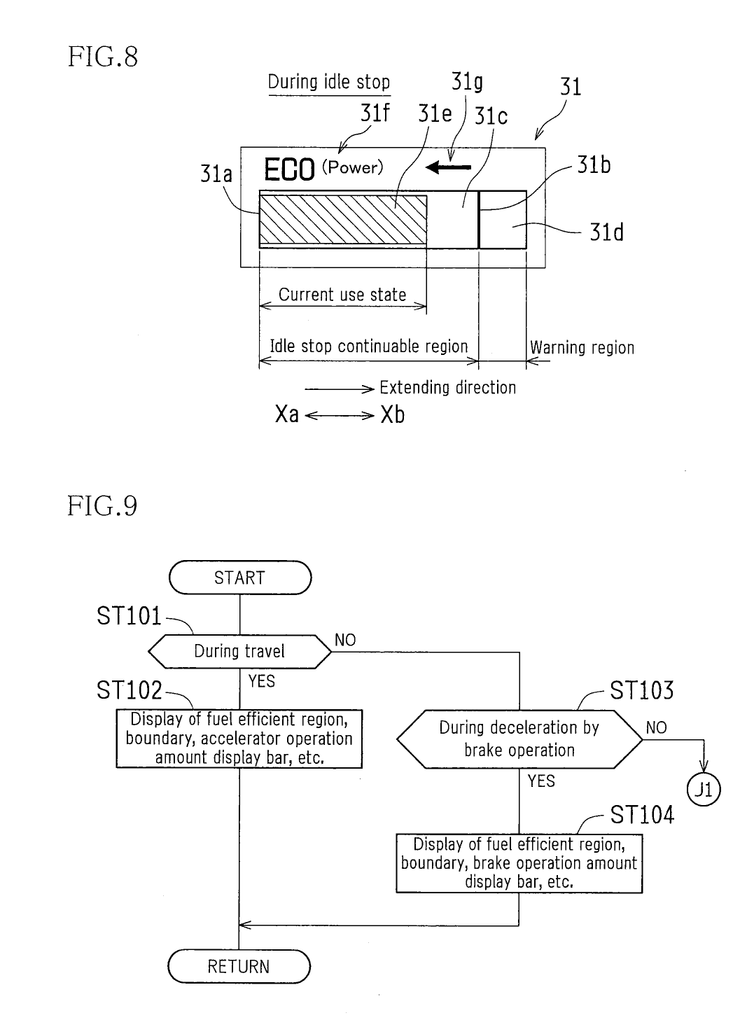

During idle stop, the display will be as shown in FIG. 8 (display indicating an electrical power use state), if the following conditions are satisfied: a current electrical power use amount is less than a reference value Thpow1 that will be described later; and a current air conditioner use amount is less than a reference value Thpow2 that will be described later.

Specifically, the driving state display unit 31 displays: a reference position 31a; an idle stop continuable region 31c and a warning region 31d, the above two regions are disposed in this order from the reference position 31a in one direction (extending direction: Xb direction); a boundary 31b between the idle stop continuable region 31c and the warning region 31d; a bar 31e that extends in one direction (Xb direction) or shortens in an Xa direction based on the current electrical power use amount (hereinafter referred to as an electrical power use state display bar 31e); characters “[ECO (Power)]” 31f; and an arrow 31g indicating an electrical power use reduction direction.

The electrical power use state display bar 31e is extendable not only from the reference position 31a to the idle stop continuable region 31c but also from the idle stop continuable region 31c to the warning region 31d over the boundary 31b.

The display position indicating the reference position 31a (position in the direction perpendicular to the Xa/Xb direction) in FIG. 8 is the same as the display position indicating the reference position 31a in FIG. 4(A). Also, the boundary 31b between the idle stop continuable region 31c and the permission region 31d, which is the boundary for visually determining that the electrical power use state is in an automatic engine stop continuable range, is displayed at a position spaced apart from the reference position 31a by a prescribed distance (same amount as shown in FIG. 4(A)) in one direction (extending direction of the electrical power use state display bar 31e: Xb direction). Therefore, the boundary 31b in FIG. 8 also is displayed at the same position as the boundary 31b in FIG. 4(A).

Display control of the electrical power use state display bar 31e shown in FIG. 8 is performed by the following processing. That is, the reference value Thpow1 of the electrical power use amount (described later) and the current electrical power use amount during idle stop are used for calculating a display length of the electrical power use state display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the electrical power use state display bar 31e is controlled based on the display length that is calculated based on the following formula (4):

Display length of electrical power use state display bar 31e=[(Current electrical power use amount)/(Reference value Thpow1 of electrical power use amount)]×100(%) (4)

Thus, by controlling the display of the electrical power use state display bar 31e that indicates the current electrical power use amount, the display length (amount of extension) of the electrical power use state display bar 31e changes based on the electrical power use amount. That is, the display length of the electrical power use state display bar 31e gets longer (i.e. the amount of extension in the Xb direction increases) as the current electrical power use amount comes closer to the reference value Thpow1 of the electrical power use amount.

(Reference Value of Electrical Power Use Amount)

In order to obtain the reference value Thpow1 of the electrical power use amount, for example, external information (external condition) is used as a parameter. The external information includes position information (information on noise and the like) related to a position of the vehicle 100, date-and-time information (information on month, date and time), and weather information (information on weather (sunny, cloudy, rainy, snowy and the like), ambient temperature and the like). A table, in which are set respective optimal electrical power use states (respective electrical power amounts) for in-vehicle devices operated by users including the driver, is used. The in-vehicle devices include, for example, the blower 52 of the air conditioner 50, a headlight, an audio device, wipers and the like. According to the external information (external condition), each optimal electrical power use amount (optimal electrical power use amount in response to the external condition) of the corresponding in-vehicle device is calculated by referring to the table, and a sum of each optimal electrical power use amount is obtained. Such a sum is added to a total value of the respective electrical power use amounts of the in-vehicle devices that are constantly driven regardless of the user's operation, thereby the reference value Thpow1 of the electrical power use amount is obtained.

Specifically, in the table, there are stored, for example, optimal electrical power use levels in five-stages (L0 (=0)-L4 (maximum)) for the blower 52, optimal electrical power use levels in three-stages (L0 (=0)−L2 (maximum)) for the headlight, optimal electrical power use levels in five-stages (L0 (=0)−L4 (maximum)) for the audio device, and optimal electrical power use levels in three-stages (L0 (=0)−L2 (maximum)) for the wipers, which are according to the external information (external condition). When the external information (external condition) means “in a less noisy environment on sunny day (daytime)”, each optimal electrical power use amount of the corresponding in-vehicle device according to such an external information is read out from the table to be summed up. For example, the following levels are read out and summed up: level L1 of the optimal electrical power use levels in five-stages (L0 (=0)−L4 (maximum)) for the blower 52, level L0 (light off) of the optimal electrical power use levels in three-stages (L0 (=0)−L2 (maximum)) for the headlight; level L2 of the optimal electrical power use levels in five-stages (L0 (=0)−L4 (maximum)) for the audio device; and level L0 (wipers off) of the optimal electrical power use levels in three-stages (L0 (=0)−L2 (maximum)) for the wipers. The above sum is added to the total value of the respective electrical power use amounts of the in-vehicle devices that are constantly driven regardless of the user's operation, thereby the reference value Thpow1 of the electrical power use amount is obtained.

The table for obtaining the optimal electrical power use amount is previously made based on previous experiments and simulations, and is stored in the ROM of the ECU 200.

Also, the external information is obtained by the vehicle navigation device 60 and the external information collecting device 70, which will be described later, and provided to the ECU 200.

(Current Electrical Power Use Amount)

During idle stop, the sum of respective current electrical power use amounts of the in-vehicle devices is calculated based on respective use states of the in-vehicle devices actually set by the user's operation (i.e. actual electrical power use levels of the respective in-vehicle devices such as the blower 52, the headlight, the audio device, and the wipers). The sum is added to the total value of the respective electrical power use amounts of the in-vehicle devices that are constantly driven regardless of the user's operation, thereby the current electrical power use amount is obtained. Furthermore, the current electrical power use amount is to be increased (i.e. the electrical power use state display bar 31e is to be extended) according to elapse of the time (integrated value of the electrical power use amount) from the start of idle stop.

It is the ECU 200 that executes the above-described respective calculation processings of the reference value of the electrical power use amount, the current electrical power use amount and the amount of extension of the display bar 31e, and the display control of the driving state display unit 31 that includes the display control of the display bar 31e.

Note that, with regard to the reference value Thpow1 of the electrical power use amount and the current electrical power use amount, the display bar 31e indicating the current use state may be displayed using only the sum of the respective in-vehicle devices operated by the user (the value not including the total value of the respective electrical power use amounts of the in-vehicle devices that are constantly driven regardless of the user's operation).

(Reference Value of Air Conditioner Use Amount and Current Air Conditioner Use Amount)

In order to obtain the reference value Thpow2 of the air conditioner use amount, for example, the external information (external condition) is used as a parameter. A table, in which are set the optimal electrical power use levels in five-stages (L0 (=0)−L4 (maximum)) for the blower 52 corresponding to the external information (external condition), is used. According to the external information (external condition), the optimal electrical power use amount of the blower 52 is calculated by referring to the table, thereby the reference value Thpow2 of the air conditioner use amount is obtained. The table for obtaining the optimal electrical power use amount of the blower 52 is previously made based on previous experiments and simulations, and is stored in the ROM of the ECU 200.

During idle stop, the actual air conditioner use amount (electrical power use amount) of the blower 52 is calculated based on the use level of the blower 52 (e.g. any one of the electrical power use levels in five-stages) actually set by the user's operation of the blower switch, thereby the current air conditioner use amount is obtained. Furthermore, the current air conditioner use amount is to be increased (i.e. the air conditioner use state display bar 31e is to be extended) according to elapse of the time (integrated value of the air conditioner use amount) from the start of idle stop.

It is the ECU 200 that executes the above-described respective calculation processings of the reference value of the air conditioner use amount and the current air conditioner use amount.

Note that the reference value of the air conditioner use amount and the current air conditioner use amount may include the air conditioner use amount based on a preset temperature of the vehicle cabin.

(Example of Display Control)

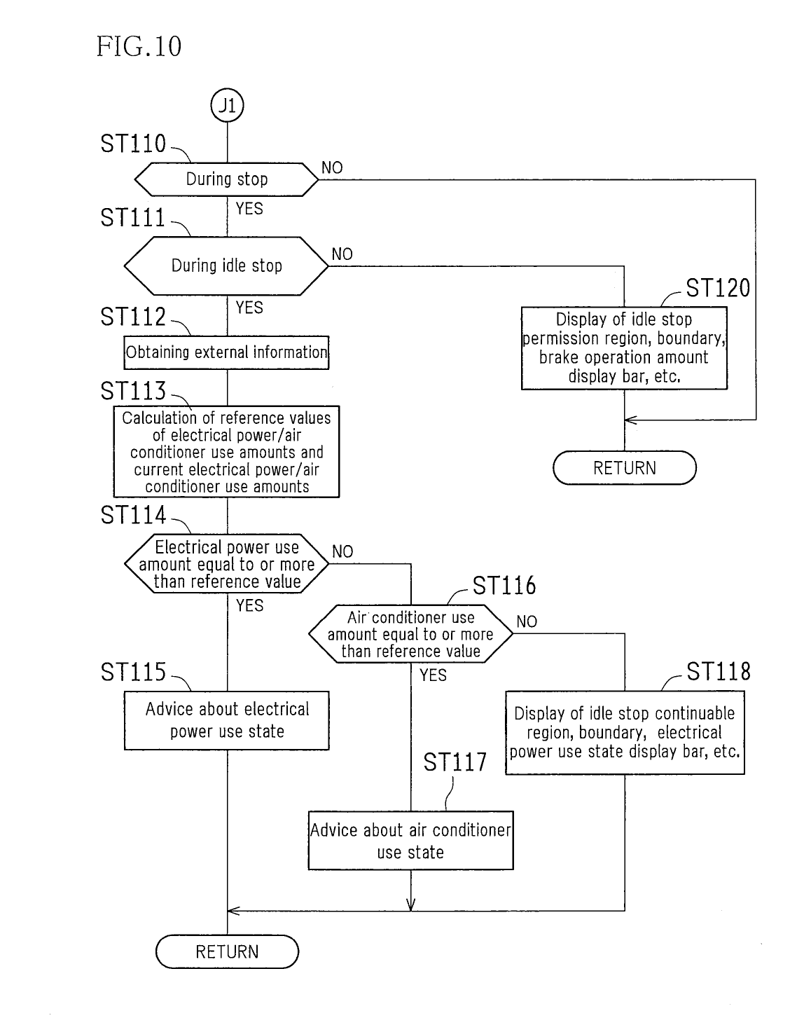

Next, an example of display control of the driving state display unit 31 will be described with reference to flowcharts shown in FIGS. 9 and 10. Control routines shown in FIGS. 9 and 10 are executed by the ECU 200 repeatedly at a prescribed time period (e.g. several microseconds).

The control routines shown in FIGS. 9 and 10 are executed during ignition-on (IG-ON). When the control routines start, first, in step ST101, it is determined whether or not the vehicle 100 is traveling based on the output signal of the vehicle speed sensor 107. If a result of determination made in step ST101 is affirmative (YES), the procedure advances to step ST102.

In step ST102, the above-described processings in [during travel] are performed. That is, the calculation processing of the accelerator operation amount determination threshold value Thaccx, the calculation processing of the amount of extension of the accelerator operation amount display bar 31e, the display control of the accelerator operation amount display bar 31e and the like are performed such that the display as shown in FIG. 4(A) is performed.

To be specific, the accelerator operation amount determination threshold value Thaccx (%) for determining fuel efficient driving is obtained based on the current vehicle speed (km/h) obtained from the output signal of the vehicle speed sensor 107, referring to the map shown in FIG. 6. The threshold value of the boundary 31b in FIG. 4(A) is set to the above-obtained accelerator operation amount determination threshold value Thaccx. Next, the display length of the accelerator operation amount display bar 31e is calculated based on the above formula (1) using the current accelerator operation amount (%) obtained from the output signal of the accelerator position sensor 102 and the accelerator operation amount determination threshold value Thaccx (%). Then, according to the calculation results and the like, the driving state display unit 31 displays, as shown in FIG. 4(A), the reference position 31a, the boundary 31b, the fuel efficient region 31c, the warning region 31d, the accelerator operation amount display bar 31e, the characters “[ECO (Accelerator)] 31f and the arrow 31g indicating the low fuel consumption direction.

Such displays allow the driver to visually determine: whether the current accelerator operation amount is in the fuel efficient region; and what level of fuel efficient drive (eco-drive) the current accelerator operation amount falls into. Here, when the tip portion of the accelerator operation amount display bar 31e enters the warning region over the boundary 31b, as shown in FIG. 5(A), due to a large operation amount of the accelerator pedal 6 by the driver, advice is given to the driver to call his/her attention. Such advice may include, for example, flashing of the warning region 31d shown in FIG. 5(A), sounding of an alarm (e.g. driving of an embedded buzzer in the combination meter 30) and display of warning characters in the driving state display unit 31.

The displays as shown in FIG. 4(A) are continuously displayed during travel of the vehicle 100 (when the affirmative determination is being made in step ST101).

If the result of determination made in step ST101 is negative (NO), the procedure advances to step ST103. In step ST103, it is determined whether or not the vehicle 100 is decelerating due to an operation of the brake pedal 7 based on the output signal of the brake pedal sensor 108. If the result of determination made in step ST 103 is affirmative (YES), the procedure advances to step ST 104.

In step ST104, the above-described processings in [during deceleration] are performed. That is, the calculation processing of the brake operation amount determination threshold value Thbrkx, the calculation processing of the amount of extension of the brake operation amount display bar 31e, the display control of the brake operation amount display bar 31e and the like are performed such that the display as shown in FIG. 4(B) is performed (switched from the display of FIG. 4(A) to that of FIG. 4(B)).

To be specific, the brake operation amount determination threshold value Thbrkx (%) for determining fuel efficient driving is obtained based on the current vehicle speed (km/h) obtained from the output signal of the vehicle speed sensor 107, referring to the map shown in FIG. 7. The threshold value of the boundary 31b in FIG. 4(B) is set to the above-obtained brake operation amount determination threshold value Thbrkx. Next, the display length of the brake operation amount display bar 31e is calculated based on the above formula (2) using the current brake operation amount (%) obtained from the output signal of the brake pedal sensor 108 and the brake operation amount determination threshold value Thbrkx (%). Then, according to the calculation results and the like, the driving state display unit 31 displays, as shown in FIG. 4(B), the reference position 31a, the boundary 31b, the fuel efficient region 31c, the warning region 31d, the brake operation amount display bar 31e, the characters “[ECO (Brake)] 31f and the arrow 31g indicating the low fuel consumption direction.

Such displays allow the driver to visually determine: whether the current brake operation amount is in the fuel efficient region; and what level of fuel efficient drive (eco-drive) the current brake operation amount falls into. Here, when the tip portion of the brake operation amount display bar 31e enters the warning region 31d over the boundary 31b, as shown in FIG. 5(B), due to a large operation amount of the brake pedal 7 by the driver, advice is given to the driver to call his/her attention. Such advice may include, for example, flashing of the warning region 31d shown in FIG. 5(B), sounding of an alarm and display of warning characters in the driving state display unit 31.

The displays as shown in FIG. 4(B) are continuously displayed during deceleration of the vehicle 100 (when the affirmative determination is being made in step ST103). When such a brake-on state returns to a brake-off state in which the vehicle 100 is traveling (when the affirmative determination is made in step ST101), the display in the driving state display unit 31 is switched to the display indicating that the vehicle is traveling (display shown in FIG. 4(A), i.e. display of the accelerator operation amount).

If the result of determination made in step ST103 is negative (NO), the procedure advances to step ST110 shown in FIG. 10. In step ST110, it is determined whether or not the vehicle 100 is being stopped based on the output signal of the vehicle speed sensor 107. If the result of determination made in step ST110 is negative (NO), i.e. when the vehicle is in a state other than that of being stopped, the procedure returns.

If the result of determination made in step ST110 is affirmative (YES), the procedure advances to step ST111. In step ST111, it is determined whether or not the vehicle 100 is in an idle stop state due to satisfaction of the above-described idle stop conditions. If the result of determination made in step ST111 is negative (NO), i.e. when the vehicle is in a state of being stopped and in a state before idle stop, the procedure advances to step ST120.

In step ST120, the above-described processings in [during stop (before idle stop)] are performed. That is, the calculation processing of the amount of extension of the brake operation amount display bar 31e, the display control of the brake operation amount display bar 31e and the like are performed such that the display as shown in FIG. 4(C) is performed.

To be specific, the threshold value of the boundary 31b in FIG. 4(C) is set to the above-described determination threshold value THbrk1 for determining idle stop. Next, the display length of the brake operation amount display bar 31e is calculated based on the above formula (3) using the current brake operation amount (%) obtained from the output signal of the brake pedal sensor 108 and the determination threshold value THbrk1 (%). Then, according to the calculation results and the like, the driving state display unit 31 displays, as shown in FIG. 4(C), the reference position 31a, the boundary 31b, the idle stop prohibition region 31c, the idle stop permission region 31d, the brake operation amount display bar 31e, the characters “[ECO (Brake)] 31f and the arrow 31g indicating the idle stop permission direction.

Such displays allow the driver to visually determine: whether the current brake operation amount reaches the idle stop permission region 31d; and to what degree the brake pedal 7 should be stepped to make the vehicle be in the idle stop (automatic engine stop) state.

The displays as shown in FIG. 4(C) are continuously displayed during stop of the vehicle 100 till the start of idle stop. When the accelerator pedal 6 is stepped during stop of the vehicle before satisfaction of the idle stop conditions such that the vehicle starts to travel (when the affirmative determination is made in step ST101), the display in the driving state display unit 31 is switched to the display indicating that the vehicle is traveling (display shown in FIG. 4(A), i.e. display of the accelerator operation amount).

If the result of determination made in step ST111 is affirmative (YES), i.e. when the vehicle 100 is in the idle stop state, the procedure advances to step ST112. In step ST112, the external information (position information, date-and-time information, weather information and the like) is obtained, which have been collected by the vehicle navigation device 60 and the external information collecting device 70. Then, the procedure advances to step ST113.

In step ST113, the above-described processings in [during idle stop] are performed so as to calculate the reference value Thpow1 of the electrical power use amount, the current electrical power use amount, the reference value Thpow2 of the air conditioner use amount and the current air conditioner use amount.

Next, in step ST114, it is determined whether or not the current electrical power use amount is equal to or more than the reference value Thpow1 of the electrical power use amount using the above-calculated reference value Thpow1 and the current electrical power use amount in step ST113. If the result of determination made in step ST114 is negative (NO), i.e. when the current electrical power use amount is less than the reference value Thpow1 (current electrical power use amount<reference value Thpow1), the procedure advances to step ST116.

In step ST116, it is determined whether or not the current air conditioner use amount is equal to or more than the reference value Thpow2 of the air conditioner use amount using the above-calculated reference value Thpow2 and the current air conditioner use amount in step ST113. If the result of determination made in step ST116 is negative (NO), i.e. when the current air conditioner use amount is less than the reference value Thpow2 (current air conditioner use amount<reference value Thpow2), the procedure advances to step ST118.

In step ST118, the display as shown in FIG. 8 is performed using the reference value Thpow1 of the electrical power use amount and the current electrical power use amount that are calculated in step ST113.

To be specific, the threshold value of the boundary 31b of FIG. 8 is set to the reference value Thpow1 of the electrical power use amount. Next, the display length of the electrical power use state display bar 31e is calculated based on the above formula (4) using the reference value Thpow1 of the electrical power use amount and the current electrical power use amount. Then, according to the calculation results and the like, the driving state display unit 31 displays, as shown in FIG. 8, the reference position 31a, the boundary 31b, the idle stop continuable region 31c, the warning region 31d, the electrical power use state display bar 31e, the characters “[ECO (Power)] 31f and the arrow 31g indicating the electrical power use reduction direction. Such displays allow the driver to visually determine how long the idle stop state can be continued.

The displays as shown in FIG. 8 are continuously displayed till either of the following condition during idle stop is not satisfied: the current electrical power use amount less than the reference value Thpow1; or the current air conditioner use amount less than the reference value Thpow2. When the current electrical power use amount becomes equal to or more than the reference value Thpow1 (when the affirmative determination is made in step ST114) during the display as shown in FIG. 8, advice is given to the driver with regard to the electrical power use state as described later. Also, when the current air conditioner use amount becomes equal to or more than the reference value Thpow2 (when the affirmative determination is made in step ST116) during the display as shown in FIG. 8, advice is given to the driver with regard to the air conditioner use state as described later.

Furthermore, when the accelerator pedal 6 is stepped such that the vehicle starts to travel (when the affirmative determination is made in step ST101), the display in the driving state display unit 31 is switched to the display indicating that the vehicle is traveling (display shown in FIG. 4(A), i.e. display of the accelerator operation amount).

If the result of determination made in step ST114 is affirmative (YES), i.e. when the current electrical power use amount is equal to or more than the reference value Thpow1 (current electrical power use amount>Thpow1), the procedure advances to step ST115. In step ST115, the advice is given to the driver with regard to the electrical power use state. When the current electrical power use amount is large, more specifically, equal to or more than the reference value Thpow1, during idle stop, the engine 1 may be automatically started before satisfaction of the idle stop release condition so as to ensure an electrical power to restart the engine 1. Therefore, the driver is advised as to such a large amount of electrical power being used. The advice may include flashing of the warning region 31d shown in FIG. 8, sounding of an alarm and display of warning characters in the driving state display unit 31.

Also, if the result of determination made in step ST116 is affirmative (YES), i.e. when the current electrical power use amount is less than the reference value Thpow1 and the current air conditioner use amount is equal to or more than the reference value of Thpow2 during idle stop, the procedure advances to step ST117. In step ST117, the advice is given to the driver with regard to the air conditioner use amount being large. The advice may include flashing of the warning region 31d shown in FIG. 8, sounding of an alarm and display of warning characters in the driving state display unit 31.

The above-described control as shown in FIGS. 9 and 10 is continuously performed during ignition-on (IG-ON), and terminated when the ignition is turned off (IG-OFF).

<Effects>

As described above, according to the present embodiment, the driver can visually determine whether the current accelerator operation amount is in the fuel efficient region based on the display in the driving state display unit 31. Also, the driver can visually determine whether the current brake operation amount is in the fuel efficient region.

Furthermore, in the present embodiment, both the accelerator operation amount and the brake operation amount are displayed as an amount of change (amount of extension of the display bar 31e) in the same direction (same side) from the same reference position 31a in the driving state display unit 31. Also, each boundary 31b for distinguishing between the fuel efficient region and the fuel inefficient region is displayed in the same direction (same side relative to a reference line 31b). Thus, a target position (the position of the boundary 31b for distinguishing the fuel efficient region) is always in the same direction (side) regardless of which operation is performed, the accelerator operation or the brake operation. Accordingly, even if the driver changes the foot position between the accelerator pedal and the brake pedal, he/she can visually confirm the display without confusion.

[Variation 1]

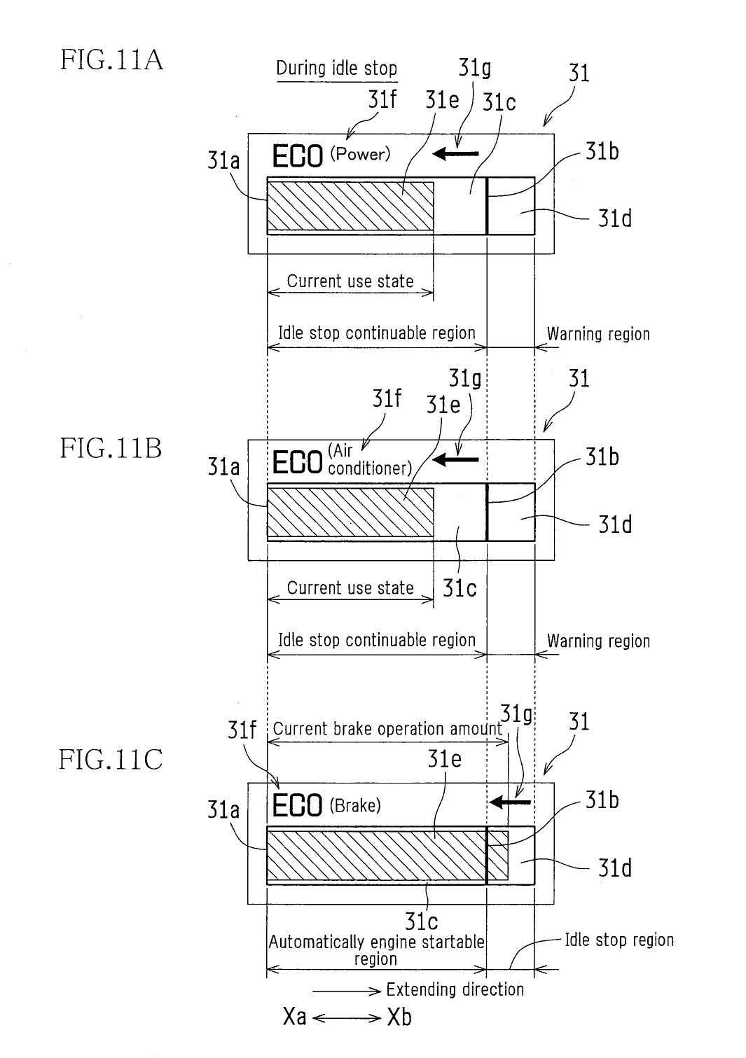

In the above-descried [embodiment 1], the driving state display unit 31 displays the display indicating the electrical power use state (see FIG. 8) when the current electrical power use amount is less than the reference value Thpow1 and the current air conditioner use amount is less than the reference value of Thpow2 during idle stop. However, the present invention is not limited thereto. The driving state display unit 31 may selectively display one of the plurality of displays including displays that indicate other states. One of the examples thereof is shown in FIGS. 11(A)-11(C). Each display shown in FIGS. 11(A)-11(C) will be described below.

The display shown in FIG. 11(A) is the same as that shown in FIG. 8 (display indicating the electrical power use state), thus a specific description thereof is not given here.

The display shown in FIG. 11(B) indicates the air conditioner use state during idle stop. The driving state display unit 31 displays: a reference position 31a; an idle stop continuable region 31c and a warning region 31d, the above two regions are disposed in this order from the reference position 31a in one direction (extending direction: Xb direction); a boundary 31b between the idle stop continuable region 31c and the warning region 31d; a display bar 31e that extends in one direction (Xb direction) or shortens in an Xa direction based on the current air conditioner use amount; characters “[ECO (Air Conditioner)]” 31f; and an arrow 31g indicating an idle stop permission direction.

The air conditioner use state display bar 31e is extendable not only from the reference position 31a to the idle stop continuable region 31c but also from the idle stop continuable region 31c to the warning region 31d over the boundary 31b.

The display position indicating the reference position 31a (position in the direction perpendicular to the Xa/Xb direction) in FIG. 11(B) is the same as the display position indicating the reference position 31a in FIG. 11(A) (FIG. 4(A)). Also, the boundary 31b between the idle stop continuable region 31c and the permission region 31d, which is the boundary for visually determining that the air conditioner use state is in an automatic engine stop continuable range, is displayed at a position spaced apart from the reference position 31a by a prescribed distance (same amount as shown in FIG. 11(A) (FIG. 4(A)) in one direction (extending direction of the air conditioner use state display bar 31e: Xb direction). Therefore, the boundary 31b in FIG. 11(B) also is displayed at the same position as the boundary 31b in FIG. 11(A) (FIG. 4(A)).

The value of the boundary 31b of this example (i.e. the air conditioner use amount determination threshold value for determining the idle stop continuable region) is set to the reference value Thpow2 of the above-described air conditioner use amount.

Display control of the air conditioner use state display bar 31e shown in FIG. 11(B) is performed by the following processing. That is, the reference value Thpow2 of the air conditioner use amount and the current air conditioner use amount are used for calculating a display length of the air conditioner use state display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the air conditioner use state display bar 31e is controlled based on the display length that is calculated based on the following formula (5):

Display length of air conditioner use state display bar 31e=[(Current air conditioner use amount)/(Reference value Thpow2 of air conditioner use amount)]×100(%) (5)

Thus, by controlling the display of the air conditioner use state display bar 31e that indicates the current air conditioner use amount, the display length (amount of extension) of the air conditioner use state display bar 31e changes based on the air conditioner use amount. That is, the display length of the air conditioner use state display bar 31e gets longer (i.e. the amount of extension in the Xb direction increases) as the current air conditioner use amount comes closer to the reference value Thpow2 of the air conditioner use amount.

The display shown in FIG. 11(C) indicates the brake operation amount during idle stop. The driving state display unit 31 displays: a reference position 31a; an automatically engine startable region 31c and an idle stop region 31d, the above two regions are disposed in this order from the reference position 31a in one direction (extending direction: Xb direction); a boundary 31b between the automatically engine startable region 31c and the idle stop region 31d; a brake operation amount display bar 31e that extends in one direction (Xb direction) or shortens in an Xa direction based on the current brake operation amount; characters “[ECO (Brake)]” 31f; and an arrow 31g indicating an automatic engine start direction.

The brake operation amount display bar 31e is extendable from the reference position 31a to the automatic engine use prohibition region 31d, and also is displacable from the automatic engine use prohibition region 31d to the automatically engine startable region 31c over the boundary 31b.

The display position indicating the reference position 31a (position in the direction perpendicular to the Xa/Xb direction) in FIG. 11(C) is the same as the display position indicating the reference position 31a in FIG. 11(A) (FIG. 4(A)). Also, the boundary 31b between the automatically engine startable region 31c and the idle stop region 31d, which is the boundary for visually determining that the brake operation amount is in an automatic engine start permission range, is displayed at a position spaced apart from the reference position 31a by a prescribed distance (same amount as shown in FIG. 11(A) (FIG. 4(A)) in one direction (extending direction of the brake operation amount display bar 31e: Xb direction). Therefore, the boundary 31b in FIG. 11(C) also is displayed at the same position as the boundary 31b in FIG. 11(A) (FIG. 4(A)).

The value of the boundary 31b of this example (i.e. the brake operation amount determination threshold value for determining the automatically engine startable region) is set to the determination threshold value THbrk2 (%) that is used for determining the above-described idle stop release condition, i.e. the condition in which the brake operation amount is less than the prescribed determination threshold value THbrk2.

Display control of the brake operation amount display bar 31e during idle stop is performed by the following processing. That is, the determination threshold value THbrk2 (%) and the current brake operation amount (%) (recognized from the output signal of the brake pedal sensor 108) are used for calculating a display length of the brake operation amount display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the brake operation amount display bar 31e is controlled based on the display length that is calculated based on the following formula (6):

Display length of brake operation amount display bar 31e=[(Current brake operation amount)/(Determination threshold value THbrk2)]×100(%) (6)

Thus, by controlling the display of the brake operation amount display bar 31e that indicates the current brake operation amount, the display length (amount of extension) of the brake operation amount display bar 31e changes based on the brake operation amount. That is, the display length of the brake operation amount display bar 31e gets longer (i.e. the amount of extension in the Xb direction increases) as the brake operation amount comes closer to the idle stop determination threshold value THbrk2. Such displays allow the driver to visually determine: whether the current brake operation amount is in the idle stop region 31d; and to what degree the brake pedal 7 should be released to make the vehicle automatically be started.

It is the ECU 200 that executes the above-described calculation processing of the display length of the brake operation amount display bar 31e and the display control of the driving state display unit 31 that includes the display control of the brake operation amount display bar 31e.

Furthermore, in this example, one of the following three displays is selectively displayed: the display of FIG. 11(A) (display of the electrical power use state during idle stop), the display of FIG. 11(B) (display of the air conditioner use state during idle stop), and the display of FIG. 11(C) (display of the brake operation amount during idle stop).

One example can be given of the above selective display, that is, a manner in which the display is switched for a predetermined time period repeatedly in the following order: [display of FIG. 11(A)], [display of FIG. 11(B)], and [display of FIG. 11(C)]. The orders other than above-described may also be adopted.

Another example can be given of the above selective display, that is, a manner in which a display having the tip portion of the display bar 31e closest to the boundary 31b is selected among the above three displays to be displayed.

[Variation 2]

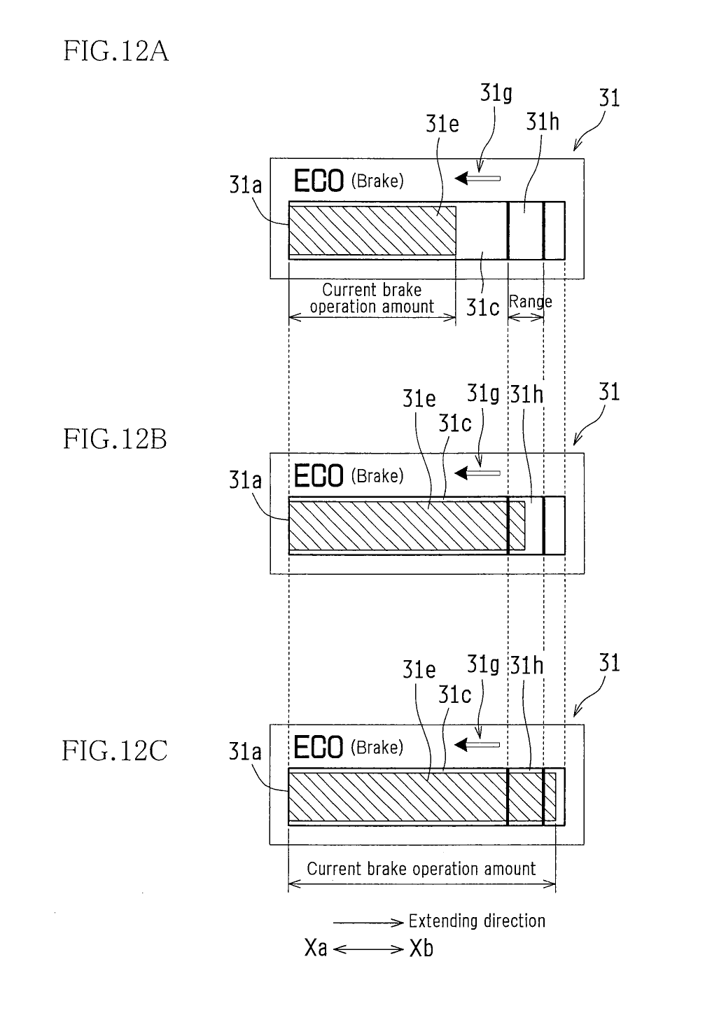

In the above-described [Embodiment 1] and [Variation 1], the boundary 31b is displayed in the driving state display unit 31. Alternatively, as shown in FIG. 12, for example, a range 31h having a maximum value and a minimum value (range for visually determining the region) may be displayed in the driving state display unit 31.

In the displays shown in FIG. 12, the driver can recognize that one of the idle stop conditions has been satisfied when the tip portion of the brake operation amount display bar 31e enters the range 31h (idle stop permission range) to remain therewithin (FIG. 12(B)), due to stepping operation of the brake pedal 7, from the state in which the tip portion of the brake amount display bar 31e remains in the region (idle stop prohibition region) 31c (FIG. 12(A)). On the other hand, the driver can recognize that the idle stop conditions have not been satisfied when the tip portion of the brake operation amount display bar 31e exceeds at once the range 31h (FIG. 12(C)) from the region (idle stop prohibition region) 31c due to a sudden deceleration and the like.

The above-described processing, that is, displaying the range 31h having the maximum value and the minimum value in the driving state display unit 31 may also be applied to the display of the accelerator operation amount during travel, the display of the brake operation amount during deceleration, the display of the electrical power use state, the display of the air conditioner use state and the like.

### Embodiment 2

Next, a description will be given of the display device that is mounted on an idle stop vehicle including a manual clutch and a manual transmission.

In such a vehicle with the manual transmission, idle stop conditions (automatic engine stop conditions) include, for example, an on-state of an ignition switch (IG-ON), an accelerator-off, a shift lever in a neutral position, a stepping operation of a clutch pedal (i.e. disconnection of the clutch) and the like. On the other hand, idle stop release conditions (automatic engine start conditions) include, for example, a connection of the clutch by operating the clutch pedal, and the like.

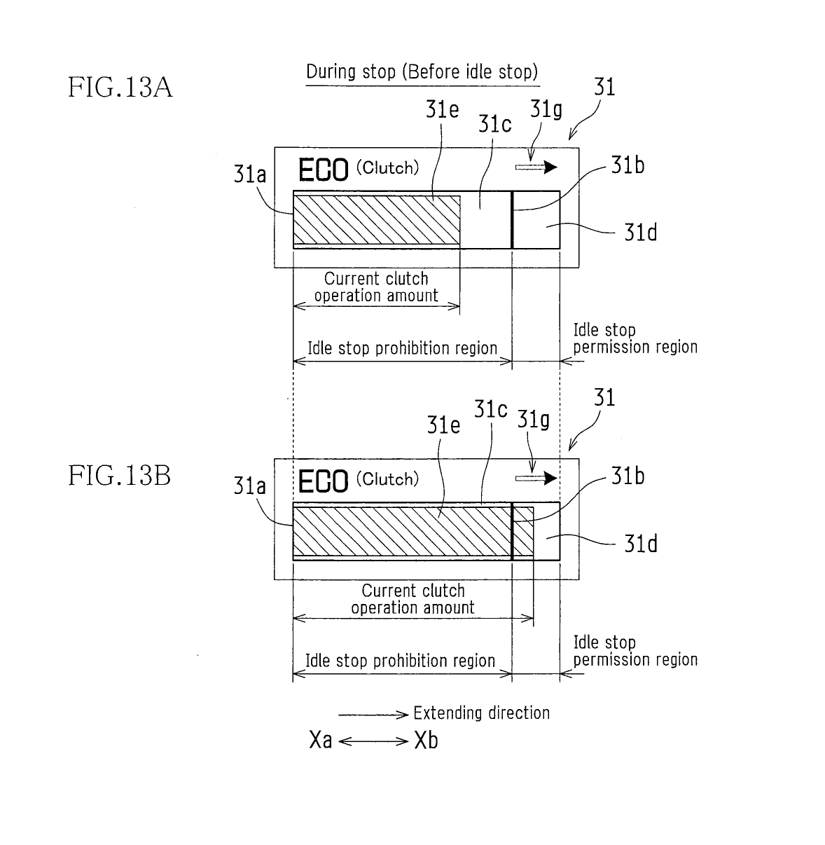

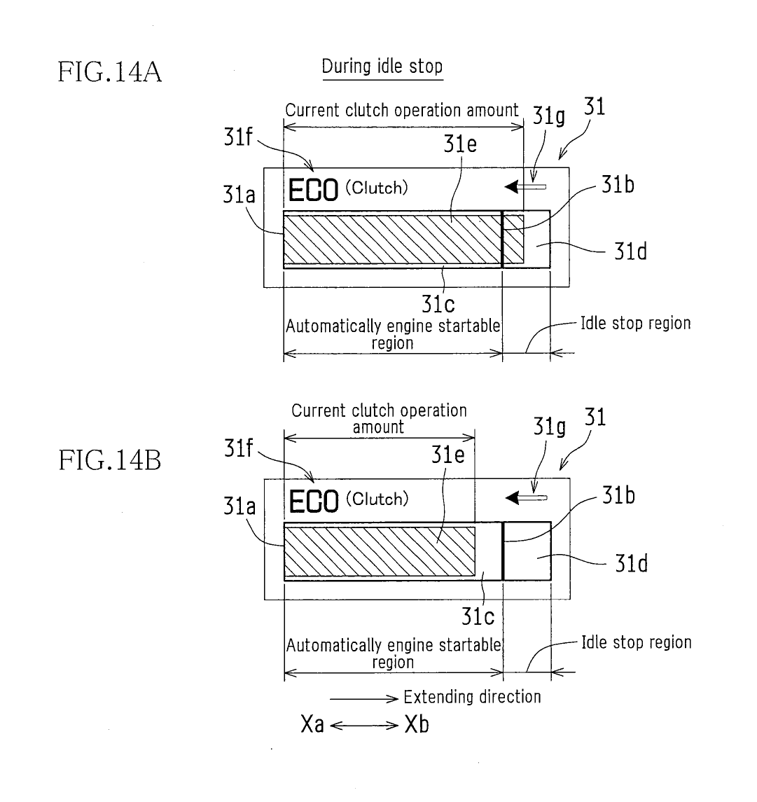

The vehicle of this example includes the combination meter 30 shown in FIG. 2, sensors such as a clutch pedal sensor for detecting a stroke of the manual clutch (clutch operation amount), the ECU and the like. In this example, an operation amount of the manual clutch is displayed in the driving state display unit 31 on the combination meter 30. A specific example thereof will be described with reference to FIGS. 13 and 14.

The displays shown in FIGS. 13(A) and 13(B) indicate the clutch operation amount during stop of the vehicle (before idle stop). The driving state display unit 31 displays: a reference position 31a; an idle stop prohibition region 31c and an idle stop permission region 31d, the above two regions are disposed in this order from the reference position 31a in one direction (extending direction: Xb direction); a boundary 31b between the idle stop prohibition region 31c and the idle stop permission region 31d; a bar 31e that extends in one direction (Xb direction) or shortens in an Xa direction based on a current clutch operation amount (hereinafter referred to as a clutch operation amount display bar 31e); characters “[ECO (Clutch)]” 31f; and an arrow 31g indicating an idle stop permission direction.

The clutch operation amount display bar 31e is extendable not only from the reference position 31a to the idle stop prohibition region 31c (FIG. 13(A)) but also from the idle stop prohibition region 31c to the idle stop permission region 31d over the boundary 31b (FIG. 13(B)).

The boundary 31b between the idle stop prohibition region 31c and the idle stop permission region 31d is displayed at a position spaced apart from the reference position 31a by a prescribed distance in one direction (extending direction of the clutch operation amount display bar 31e: Xb direction). The display position indicating the reference position 31a (position in the direction perpendicular to the Xa/Xb direction) in FIG. 13(A) is the same as the display position indicating the reference position 31a in FIG. 13(B). Furthermore, the boundary 31b of FIG. 13(A) and the boundary 31b of FIG. 13(B) are displayed at the respective positions each spaced apart from the corresponding reference position 31a by the same distance.

The value of the boundary 31b of this example (i.e. a clutch operation amount determination threshold value THclt1 for determining the idle stop permission region) is set to a clutch stroke value of the disconnection position of the manual clutch. Therefore, during stop (before idle stop) of the vehicle, when the tip portion of the clutch operation amount display bar 31e enters the idle stop permission region 31d over the boundary 31b as shown in FIG. 13(B), one condition among the idle stop conditions is satisfied.

Display control of the clutch operation amount display bar 31e during stop (before idle stop) of the vehicle is performed by the following processing. That is, the clutch operation amount determination threshold value THclt1 and the current clutch operation amount (recognized from the output signal of the clutch pedal sensor) are used for calculating a display length of the clutch operation amount display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the clutch operation amount display bar 31e is controlled based on the display length that is calculated based on the following formula (7):

Display length of clutch operation amount display bar 31e=[(Current clutch operation amount)/(Determination threshold value THclt1)]×100(%) (7)

Such displays shown in FIG. 13 allow the driver to visually determine: whether the current clutch operation amount reaches the idle stop permission region 31d; and to what degree the clutch pedal should be stepped to make the vehicle be in the idle stop (automatic engine stop) state.

The displays shown in FIGS. 14(A) and 14(B) indicate the clutch operation amount during idle stop. The driving state display unit 31 displays: a reference position 31a; an automatically engine startable region 31c and an idle stop region 31d, the above two regions are disposed in this order from the reference position 31a in one direction (extending direction: Xb direction); a boundary 31b between the automatically engine startable region 31c and the idle stop region 31d; a clutch operation amount display bar 31e that extends in one direction (Xb direction) or shortens in an Xa direction based on a current clutch operation amount (hereinafter referred to as a clutch operation amount display bar 31e); characters “[ECO (Clutch)]” 31f; and an arrow 31g indicating an automatically engine startable direction.

The clutch operation amount display bar 31e is extendable from the reference position 31a to the automatic engine use prohibition region 31d (FIG. 14(A)), and also is displacable from the automatic engine use prohibition region 31d to the automatically engine startable region 31c over the boundary 31b (FIG. 14(B)).

The boundary 31b between the automatically engine startable region 31c and the idle stop region 31d is displayed at a position spaced apart from the reference position 31a by a prescribed distance in one direction (extending direction of the clutch operation amount display bar 31e: Xb direction). The display position indicating the reference position 31a (position in the direction perpendicular to the Xa/Xb direction) in FIG. 14(A) is the same as the display position indicating the reference position 31a in FIG. 14(B). Furthermore, the boundary 31b of FIG. 14(A) and the boundary 31b of FIG. 14(B) are displayed at the respective positions each spaced apart from the corresponding reference position 31a by the same distance.

The value of the boundary 31b of this example (i.e. a clutch operation amount determination threshold value THclt2 for determining the automatically engine startable region) is set to a clutch stroke value of the connection position of the manual clutch. Therefore, during idle stop, when the tip portion of the clutch operation amount display bar 31e enters the automatically engine startable region 31c from the idle stop region 31d over the boundary 31b as shown in FIG. 14(B), the idle stop release condition (automatic engine start condition) is satisfied.

Display control of the clutch operation amount display bar 31e during idle stop is performed by the following processing. That is, the clutch operation amount determination threshold value THclt2 and the current clutch operation amount (recognized from the output signal of the clutch pedal sensor) are used for calculating a display length of the clutch operation amount display bar 31e (length from the reference position 31a to the tip portion of the display bar 31e in the extending direction or Xb direction, i.e. amount of displacement of the display bar 31e in one direction from the reference position 31a) that is displayed in the driving state display unit 31. Display of the clutch operation amount display bar 31e is controlled based on the display length that is calculated based on the following formula (8):

Display length of clutch operation amount display bar 31e=[(Current clutch operation amount)/(Determination threshold value THclt2)]×100(%) (8)

Such displays shown in FIG. 14 allow the driver to visually determine: whether the current clutch operation amount is in the idle stop region 31d; and to what degree the clutch pedal should be released to make the engine be automatically started.

It is the ECU that executes the above-described calculation processing of the display length of the clutch operation amount display bar 31e and the display control of the driving state display unit 31 that includes the display control of the clutch operation amount display bar 31e.

In the display device that is mounted on the vehicle with the manual transmission, the following displays may be displayed: the display of FIG. 4(A) (display of the accelerator operation amount during travel), the display of FIG. 4(B) (display of the brake operation amount during deceleration), the display of FIG. 8 (FIG. 11(A)) (display of the electrical power use state during idle stop), the display of FIG. 11(B) (display of the air conditioner use state during idle stop), and the like.

Also, in the display device that is mounted on the vehicle with the manual transmission, the driving state display unit 31 may display the range 31h having a maximum value and a minimum value (range for visually determining the region, see 12) in place of the boundary 31b, as indicated in the [Variation 2] of [Embodiment 1].

### Other Embodiments

The embodiments disclosed herein are in all respects merely illustrative and are not to be construed in limiting fashion. Therefore, the scope of the present invention is not to be construed in any way whatsoever by only the foregoing embodiments, but to be indicated by the claims. All modifications and changes within the range of equivalents of the claims are, moreover, within the scope of the present invention.

For example, the foregoing embodiments and comparable examples have described a configuration in which the driving state display unit is provided on the combination meter so as to display the accelerator operation amount and the boundary (range), the brake operation amount and the boundary (range), and the like. However, the present invention is not limited thereto. A display unit may be disposed on a location other than the combination meter so as to display the accelerator operation amount and the boundary (range), the brake operation amount and the boundary (range), and the like, provided that such a location can be seen by the driver. The accelerator operation amount and the boundary (range), the brake operation amount and the boundary (range), and the like may also be displayed on a display screen of the vehicle navigation device, or a dedicated display device may be provided to display the accelerator operation amount and the boundary (range), the brake operation amount and the boundary (range), and the like.

The two displays, i.e. the accelerator operation amount and the boundary (range), and the brake operation amount and the boundary (range), may be vertically arranged, provided that the respective reference positions (31a) of the two displays are vertically arranged (located on the same line), and that the respective boundaries (31b) of the two displays are vertically arranged (located on the same line). In the foregoing embodiments and comparable examples, the accelerator operation amount display bar (bar graph), the brake operation amount display bar (bar graph) and the like are extendable in the horizontal direction (Xb direction). However, such display bars may be vertically extendable from bottom to top.

In the foregoing embodiments and comparable examples, an example has been described in which the present invention is applied to the display device mounted on an idle stop vehicle that performs an automatic engine stop. However, the present invention is not limited thereto. The present invention may also be applied to a vehicle that does not have an automatic engine stop function.

In the foregoing embodiments and comparable examples, an example has been described in which the present invention is applied to the display device mounted on an FF vehicle. However, the present invention is not limited thereto. The present invention may also be applied to the display device mounted on an FR (front engine/rear drive) vehicle or a 4WD (four wheel drive) vehicle.

In the foregoing embodiments and comparable examples, an example has been described in which the present invention is applied to the display device mounted on a vehicle equipped with, as a power source, an engine such as a gasoline engine and a diesel engine. However, the present invention is not limited thereto. The present invention may also be applied to the display device mounted on a hybrid vehicle equipped with an engine and an electric motor (motor generator and the like) as power sources.

### INDUSTRIAL APPLICABILITY

The present invention is suitable for use in a display device for displaying a driving operation state of a vehicle by a driver. More specifically, the present invention is suitable for use in a display device for teaching a fuel efficient drive operation to the driver.

### DESCRIPTION OF REFERENCE NUMERALS

100 Vehicle
1 Engine
6 Accelerator pedal
7 Brake pedal
30 Combination meter
31 Driving state display unit
102 Accelerator position sensor
107 Vehicle speed sensor
108 Brake pedal sensor
200 ECU

1. A display device for displaying a driving operation state of a vehicle by a driver,
wherein in response to an accelerator operation, an accelerator operation amount is displayed as an amount of displacement from a reference position in one direction, and a boundary or range is displayed at a position spaced apart from the reference position by a prescribed distance in the one direction such that the accelerator operation amount can be visually determined to be in a fuel efficient region, and
wherein in response to a brake operation, a brake operation amount is displayed as an amount of displacement from the reference position in the one direction, and a boundary or range is displayed at a position spaced apart from the reference position by a prescribed distance in the one direction such that the brake operation amount can be visually determined to be in the fuel efficient region.

2. The display device according to claim 1,
wherein during the accelerator operation, neither the brake operation amount nor the boundary or range for visually determining the brake operation amount being in the fuel efficient region is displayed.

3. The display device according to claim 1,
wherein during the brake operation, neither the accelerator operation amount nor the boundary or range for visually determining the accelerator operation amount being in the fuel efficient region is displayed.

4. The display device according to claim 1,
wherein both the boundary or range for visually determining the accelerator operation amount and the boundary or range for visually determining the brake operation amount are displayed at a position spaced apart from the reference position by the same distance.

5. The display device according to claim 1,
wherein the vehicle is an idle stop vehicle capable of performing an automatic engine stop based on the brake operation amount, and
wherein a display during the brake operation before the automatic engine stop is a display of a boundary or range for visually determining whether or not the brake operation amount is in an automatic engine stop permission range.

6. The display device according to claim 1,
wherein the vehicle is an idle stop vehicle capable of performing an automatic engine start based on the brake operation amount, and
wherein a display of the brake operation amount during the automatic engine stop is a display of a boundary or range for visually determining whether or not the brake operation amount is in an automatic engine start permission range.

7. The display device according to claim 1,
wherein the vehicle is an idle stop vehicle capable of performing an automatic engine start based on the brake operation amount, and
wherein a display during the automatic engine stop is a display selected from the following three displays: a display of a boundary or range for visually determining whether or not an electrical power use state is in an automatic engine stop continuable range; a display of a boundary or range for visually determining whether or not an air conditioner use state is in the automatic engine stop continuable range; and a display of a boundary or range for visually determining whether or not the brake operation amount is in an automatic engine start permission range.
